(19) United States
(12) Patent Application Publication
(10) Pub. No.: US 2014/0053702 A1
(43) Pub. Date: Feb. 27, 2014

(54) Device for Cutting a Ribbon Made of Paper, Plastics or Similar Material

(71) Applicant: P.E. LABELLERS S.P.A., PORTO MANTOVANO (IT)

(72) Inventor: MARIO BALLAROTTI, MARMIROLO (IT)

(73) Assignee: P.E. LABELLERS S.P.A., PORTO MANTOVANO (IT)

(21) Appl. No.: 14/063,060

(22) Filed: Oct. 25, 2013

Related U.S. Application Data
(62) Division of application No. 12/227,129, filed on Nov. 7, 2008.

(30) Foreign Application Priority Data
May 19, 2006 (IT) MN2006A000040

(51) Int. Cl. B26D 1/06

(52) U.S. Cl. CPC B26D 1/065
USPC 83/613

(57) ABSTRACT

A device for cutting a ribbon made of paper, plastics or similar material, comprising a blade (8) connected to actuation means which are adapted to give the blade (8) a motion toward the ribbon (11), the blade comprising a component parallel to the surface of the ribbon (11).

### CROSS REFERENCE TO RELATED APPLICATIONS

This application is a continuation of, and claims the benefit of U.S. patent application Ser. No. 12/227,129 which was filed on 07 Nov. 2008 under 35 U.S.C. 371 as the U.S. national stage of International Patent Application Number PCT/EP2007/004261 filed on 14 May 2007 which claims priority to Italian Patent Application Number MN2006A000040 filed on 19 May 2006, all of which said applications are herein incorporated by reference in their entirety.

### TECHNICAL FIELD

The invention relates to a device for cutting a ribbon made of paper, plastics or similar material.

### BACKGROUND

It is known that currently the devices that cut ribbons made of paper, plastics or similar material which unwind from a roll comprise a blade which is moved into abutment against a fixed complementary blade providing in practice a scissor-like effect.

This is the case, for example, of ribbons on which labels are imprinted which must be separated by cutting before they are applied to bottles in labeling machines.

Conventional scissor-like devices allow a rather limited productivity and are further difficult to fine-tune, and therefore the aim of the present invention is to provide a cutting device which allows high productivity and can be installed simply and rapidly.

### BRIEF SUMMARY

This aim is achieved by a device for cutting a ribbon made of paper, plastics or similar material, according to the invention, characterized in that it comprises a blade connected to actuation means which are adapted to give said blade a motion toward the ribbon, said blade comprising a component parallel to the surface of said ribbon.

### BRIEF DESCRIPTION OF THE DRAWINGS

Further characteristics and advantages of the invention will become better apparent from the description of two preferred but not exclusive embodiments thereof, illustrated by way of non-limiting example in the accompanying drawings, wherein:

FIG. 1 is a perspective view of the device according to the invention, mounted on a labeling machine, showing in dot-and-dash lines the ribbon to be cut, on which the individual labels are imprinted sequentially;

FIG. 2 is a front view of the embodiment of the device shown in FIG. 1, from the opposite side with respect to the one shown in FIG. 1;

FIG. 3 is a view, with a part in phantom lines, of a variation of the device according to the invention.

### DETAILED DESCRIPTION

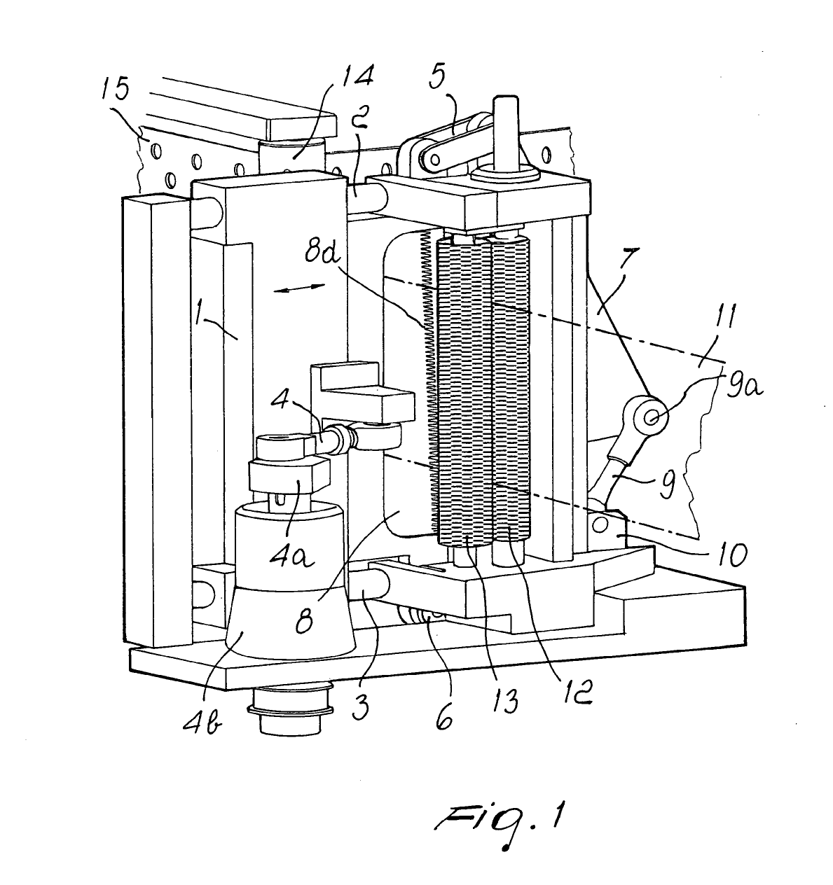

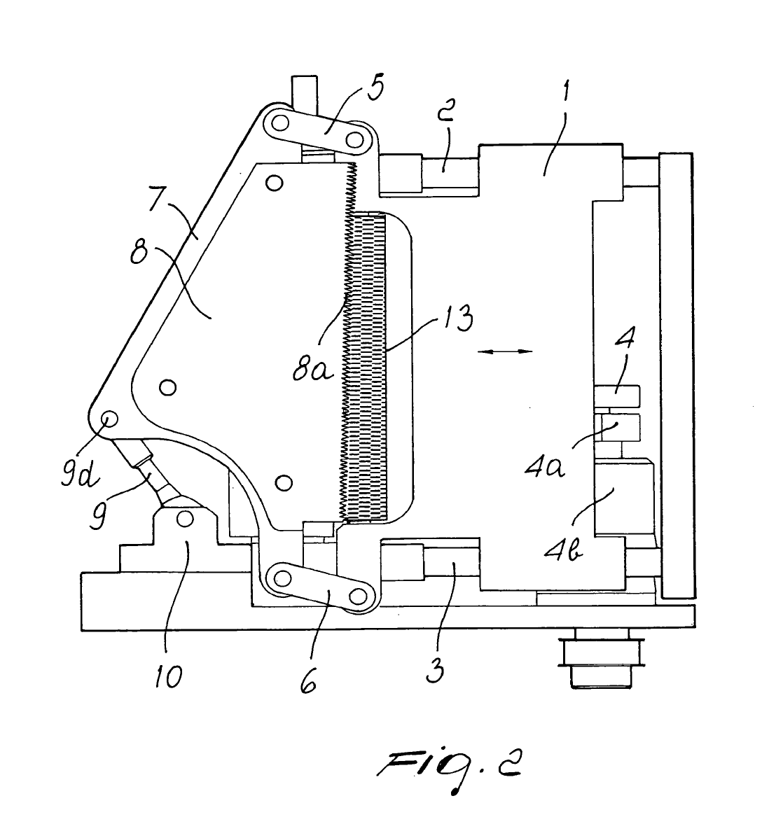

With reference to FIGS. 1 and 2, the reference numeral 1 designates a slider which is provided with a reciprocating rectilinear motion along fixed guides 2 and 3, since it is connected to an end of a linkage 4 which is moved by an eccentric element 4a which is connected to a shaft inserted in a support 4b and is turned by motor means not shown in the figures.

Two rockers 5 and 6 for connection to a plate 7 for supporting a blade 8 are pivoted to the slider 1, and the plate 7 is rigidly coupled by means of a pivot 9a to one end of a linkage 9, which at the other end is pivoted to a fixed support 10.

Accordingly, the blade 8 is moved with a complex motion which comprises, in its approach to a ribbon 11 in output from traction rollers 12 and 13, shown by way of reference in dot-and-dash lines, a component which is parallel to the surface of such ribbon.

The individual labels separated after cutting, which occurs very quickly and precisely, are picked up by a conveyor belt 15 and accompanied by means of a roller 14.

The blade 8 has a saw-tooth edge 8a such as to have a slight inclination when it comes into contact with the ribbon 11 with respect to the surface of said ribbon, but said edge might equally be straight and might be parallel to the surface of the ribbon upon contact with said ribbon.

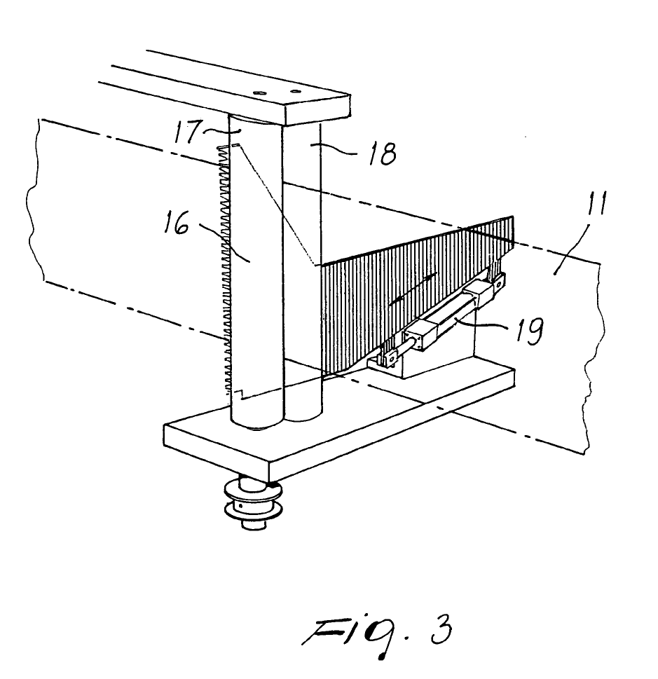

FIG. 3 is a view of a variation of the device according to the invention which provides for the presence of means for actuating a blade 16, which is shown in phantom lines in the portion behind traction rollers 17 and 18, which comprise an actuation cylinder 19, such as to give the blade 16 a motion of approach toward the ribbon 11 which is rectilinear along the arrow shown in the figure and is such as to comprise a component which is parallel to the surface of the ribbon.

The invention is susceptible of numerous modifications and variations in addition to those described, all of which are within the scope of the appended claims: thus, for example, the means for actuating the blade might be provided in any manner.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1. A device for cutting a ribbon made of paper, plastics or similar material, characterized in that it comprises a blade (8, 16) connected to actuation means (19) which are adapted to give said blade a motion toward the ribbon (11), the blade comprising a component parallel to the surface of said ribbon (11).

2. The device according to claim 1, characterized in that the blade has a straight edge.

3. The device according to claim 1, characterized in that the blade (8) has a saw-tooth edge (8a).

4. The device according to claim 1, characterized in that the blade (8), when it comes into contact with the ribbon (11), has its edge inclined with respect to the surface of said ribbon.

5. The device according to claim 1, characterized in that the blade (8), when it comes into contact with the ribbon, has its edge parallel to the surface of said ribbon.

6. The device according to claim 1, characterized in that the means for actuating the blade (8) comprise a motor which is adapted to give said blade a rectilinear motion.

7. The device according to claim 1, characterized in that the blade actuation means comprise a slider (1) which is provided with a reciprocating rectilinear motion to which two rockers (5, 6) for connecting to a blade supporting plate (7) are pivoted at one end, said blade being rigidly coupled by means of a pivot (9a) to an end of a linkage (9) which is pivoted at the other end to a fixed support (10).
